(19) United States
(12) Patent Application Publication
(10) Pub. No.: US 2004/0179867 A1
(43) Pub. Date: Sep. 16, 2004

(54) Method and apparatus for improved printing with toner having magnetic content

(76) Inventor: John F. Crichton, Honeoye Falls, NY (US)

Correspondence Address: Kevin L. Leffel, Heidelberg Digital L.L.C., 2600 Manitou Road, Rochester, NY, 14624, US

(21) Appl. No.: 10/772,870

(22) Filed: Feb. 6, 2004

Related U.S. Application Data
(60) Provisional application No. 60/453,868, filed on Mar. 11, 2003.

(51) Int. Cl. G03G 15/09

(52) U.S. Cl. 399/267; 399/277

(57) ABSTRACT

An electrographic development machine that utilizes magnetic toner particles includes a dielectric film member for carrying an electrostatic image thereon. A toner roller is disposed upon a first side of the dielectric film member. The toner roller has a core and an outer shell. The core includes a plurality of toner roller magnets, each of which have a respective north and south pole. The toner roller magnets are disposed such that adjacent pairs thereof have poles of opposite polarity disposed proximate the shell. The toner roller provides the dielectric film member with a supply of developer material. The machine further includes means for altering or balancing the magnetic forces acting on the developer.

This application claims the benefit of U.S. Provisional Patent Application serial No. 60/453,868 filed Mar. 11, 2003.

### FIELD OF THE INVENTION

The present invention relates to electrographic development and/or printing apparatuses which use toner having magnetic content to develop electrostatic images carried on an insulating surface.

### DESCRIPTION OF THE RELATED ART

The process of electrography involves forming an electrostatic charge image on a dielectric surface, typically the surface of a photoconductive recording element that is being drawn or otherwise conveyed through a developing station or toning zone. The image is developed by bringing a two-component developer into contact with the electrostatic image and/or the dielectric surface upon which the image is disposed. The developer includes a mixture of pigmented resinous particles generally referred to as toner and magnetically-attractable particles generally referred to as carrier. The nonmagnetic toner particles impinge upon the carrier particles and thereby acquire a triboelectric charge that is opposite the charge of the electrostatic image. The developer and the electrostatic image are brought into contact with each other in the toning zone, wherein the toner particles are stripped from the carrier particles and attracted to the image by the relatively strong electrostatic force thereof. Thus, the toner particles are deposited on the image. The magnetic carrier particles are drawn to the toning shell by the rotating magnets therein. This magnetic force generally does not affect the nonmagnetic toner particles.

However, within the toning zone the toner particles are affected by forces other than the electrostatic force attracting the toner to the image and which may degrade image quality. These forces include, for example, repulsion of toner from the portion of the dielectric surface or photoconductive element that corresponds to the background area of the image, electrical attraction of the toner particles to the carrier particles, repulsion of toner particles from other toner particles, and electrical attraction to or repulsion from the toning shell depending on the polarity of the film voltage in the developer nip area. Methods of compensating for and/or balancing the effect of these other forces on the nonmagnetic toner particles to prevent any significant adverse effect on image quality are well known in the art. However, the forces on toner particles having magnetic content are very different from the forces on nonmagnetic toner.

In addition to the electrical forces acting on nonmagnetic toner as described above, toner having magnetic content is subjected to magnetic forces, such as, for example, magnetic attraction of the toner particles to the carrier particles, to other toner particles, and to the rotating core magnet. All of these magnetic forces are generally in a direction away from the film or electrostatic image carrier. The only force acting to draw the toner onto the electrostatic image carried by the film or dielectric carrier is the electric force. Thus, the magnetic forces tend to counteract the electric attraction of toner particles to the image. The strength of the electric force relative to the magnetic forces becomes stronger as the distance between the image and the core magnet increases. Therefore, the toner tends to be deposited on the trailing edge of the film or dielectric carrier. The result is an image having solids with heavy toning on the trailing edge of the image, and cross track lines (i.e., lines perpendicular to the direction of travel of the dielectric support member or film) that are wider than the corresponding in track lines (i.e., lines that are parallel to the direction of travel of the dielectric support member or film).

Therefore, what is needed in the art is a method and apparatus for balancing the magnetic forces within an electrographic development and/or printing machine utilizing magnetic toner.

### SUMMARY OF THE INVENTION

The present invention provides a method and apparatus for balancing the magnetic forces within an electrographic development using magnetic toner.

The invention comprises, in one form thereof, an electrographic development machine including a dielectric film member for carrying an electrostatic image thereon. A toner roller is disposed upon a first side of the dielectric film member. The toner roller has a core and an outer shell. The core includes a plurality of radially-disposed toner roller magnets, each of which has a respective north and south pole. The toner roller magnets are disposed such that adjacent pairs thereof have poles of opposite polarity disposed proximate the shell. The toner roller provides the dielectric film member with a supply of developer material. The machine further includes means for balancing the magnetic forces acting on the magnetic toner particles.

An advantage of the present invention is that the undesirable effects of magnetic forces upon the magnetic toner are substantially reduced.

### BRIEF DESCRIPTION OF THE DRAWINGS

The above-mentioned and other features and advantages of this invention, and the manner of attaining them, will become apparent and be better understood by reference to the following description of one embodiment of the invention in conjunction with the accompanying drawings, wherein:

FIG. 1 is a side, elevation view, partially in cross-section, of a prior art toning or development station of an electrographic development machine;

FIG. 2 illustrates the electrical and magnetic forces acting on an exemplary nonmagnetic toner particle and an exemplary carrier particle in the conventional electrographic development machine of FIG. 1;

FIG. 3 illustrates the electrical and magnetic forces acting on an exemplary magnetic toner particle and an exemplary carrier particle in the conventional electrographic development machine of FIG. 1; and

FIG. 4 is a side, cross-sectional view of one embodiment of an electrographic development machine of the present invention, and illustrates the electrical and magnetic forces acting on an exemplary magnetic toner particle and an exemplary carrier particle therein.

FIG. 5 a side, cross-sectional view of a second embodiment of an electrographic development machine of the present invention, and illustrates the electrical and magnetic forces acting on an exemplary magnetic toner particle and an exemplary carrier particle therein; and

FIG. 6 a side, cross-sectional view of a third embodiment of an electrographic development machine of the present invention, and illustrates the electrical and magnetic forces acting on an exemplary magnetic toner particle and an exemplary carrier particle therein.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE DRAWINGS

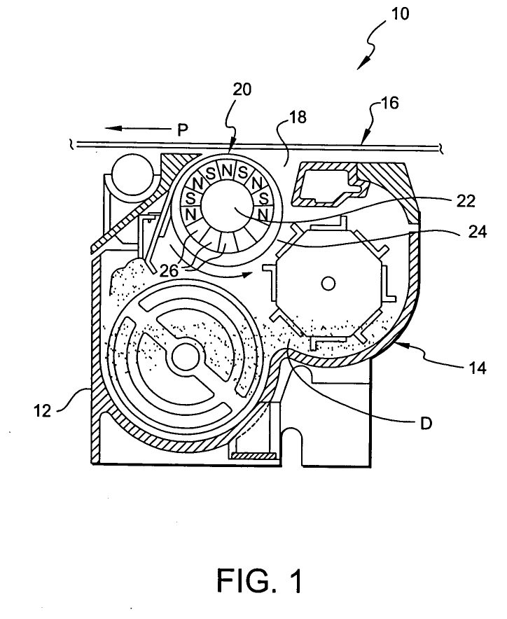

Referring now to the drawings and particularly to FIG. 1, there is shown a prior art toning or development station of an electrographic development or printing machine. Development station 10 is configured as a magnetic brush type, and includes housing 12 that defines reservoir 14 within which developer material D is disposed. The developer material D is, for example, a two-component small particle developer material having magnetic carrier particles of from approximately 20 to approximately 40 microns in diameter intermixed with nonmagnetic pigmented toner particles. Dielectric support member 16 is conveyed or moved in direction P past opening 18 in the upper portion of housing 12. The magnetic brush may operate according to the principles described in U.S. Pat. Nos. 4,473,029 and 4,546,060, the contents of which are fully incorporated by reference as if set forth herein. The carrier particles may (a) comprise a magnetic material exhibiting “hard” magnetic properties, as characterized by a coercivity of at least 300 gauss and (b) exhibit an induced magnetic moment of at least 20 EMU/gm when in an applied field of 1000 gauss.

Toner roller 20 is disposed proximate opening 18. Generally, toner roller 20 applies toner to one or more latent images in the form of an electrostatic charge (neither of which are shown) formed on and carried by dielectric support member 16 as it moves or is conveyed in direction P past opening 18. Toner roller 20 includes a core 22 surrounded by a cylindrical shell 24. Core 22 includes a plurality of magnets 26 disposed around the outer surface thereof such that the poles at the outer portions of magnets 26 are arranged in alternating polarity as shown. Shell 24 is constructed of a nonmagnetic material, and may optionally have an axis (not referenced) that is offset from the axis (not referenced) of core 22 to thereby decrease the field strength of magnets 26 over the area of shell 24 that is furthest from magnets 26. Developer material D is less likely to adhere to shell 24 in the area of decreased magnetic field strength, i.e., the offset area, and is thus more likely to return to reservoir 14.

In the embodiment shown, core 22 and magnets 26 are rotating clockwise, and shell 24 is rotating counterclockwise. However, it is to be understood that core 22 and shell 24 can be either fixed or rotatable, so long as developer material D is caused thereby to move in the field lines of magnets 26, through opening 18, and into contact with dielectric member 16.

As support member 16 moves past opening 18, the latent image carried thereby in the form of an electrostatic charge attracts toner particles of developer material D from toner roller 20, through opening 18 and into adherence with the electrostatic charge on support member 16. The developed pattern is then typically transferred from support member 16 to a final substrate (not shown), such as, for example, a piece of paper.

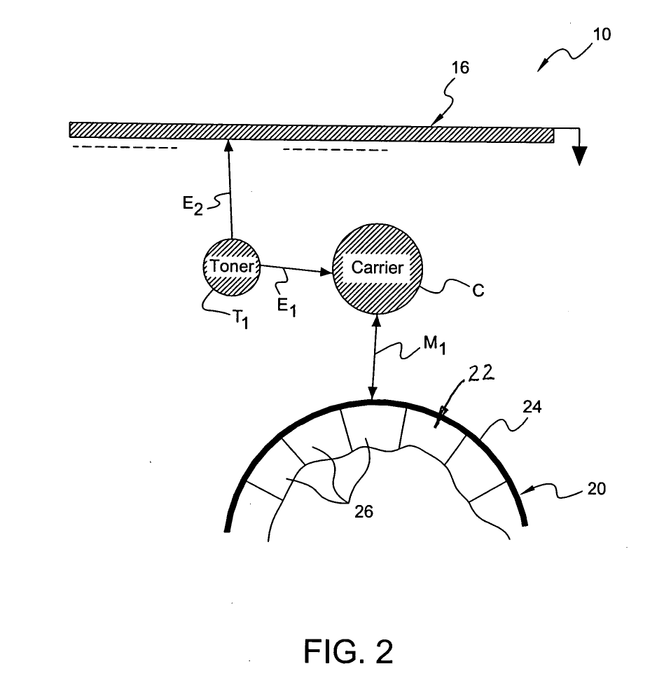

The electrical and magnetic forces acting on an exemplary nonmagnetic toner particle T₁ and an exemplary carrier particle C in conventional electrographic printing machine 10 are illustrated in FIG. 2. Carrier particle C is alternately attracted to and repulsed from toning roller 20 by magnetic force M₁. The alternating nature or direction of force M₁ is due to the rotation of toning roller 20 and, thus, magnets 26. Nonmagnetic toner particle T₁ is attracted to carrier particle C by electrical force E₁, which is the relatively weak electrostatic force that bonds toner particles to the carrier particles. Toner particle T₁ is attracted to support member 16 by force E₂, i.e., the electrostatic image charge. When the electrical forces are properly balanced, force E₂ will be sufficiently stronger than force E₁ to cause toner particle T₁ to be stripped from carrier particle C and lodge onto a portion of the electrostatic image charged carried by support member 16. In part, the electrical forces are balanced by a development electrode layer (not shown), such as, for example, a layer of nickel, of dielectric support member 16 that is held at ground potential. The nonmagnetic toner particle T₁ is not significantly affected by magnetic force M₁.

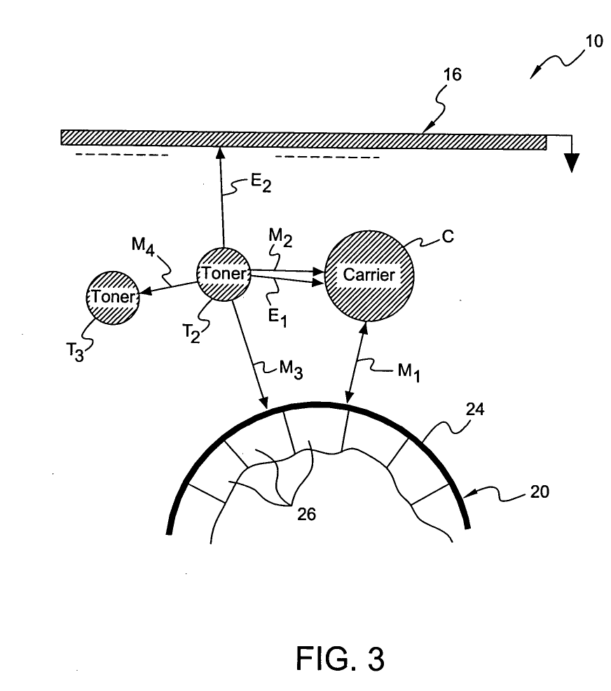

Referring now to FIG. 3, the electrical and magnetic forces acting within conventional electrographic printing machine 10 upon an exemplary toner particle having magnetic content T₂ and exemplary carrier particle C are illustrated. Magnetic force M₁ continues to act on carrier particle C to alternately attract and repulse carrier particle C to and from toning roller 20. Electrical force E₁ acts on magnetic toner particle T₂ in a substantially identical manner as it acted on nonmagnetic toner particle T₁, i.e., tending to bond magnetic toner particle T₂ to carrier particle C. Electrical force E₂ also acts on magnetic toner particle T₂ in a substantially identical manner as it acted on nonmagnetic toner particle T₁, i.e., magnetic toner particle T₂ is attracted by force E₂ to the electrostatic image charge carried by support member 16. Magnetic toner particle T₂ is, however, subjected to magnetic forces that did not significantly affect nonmagnetic toner particle T₁.

Magnetic toner particle T₂ is acted upon by magnetic forces M₂, M₃, and M₄. More particularly, magnetic force M₂ exists between toner particle T₂ and carrier particle C, and tends to draw toner particle T₂ toward carrier particle C. Magnetic force M₃ exists between toner particle T₂ and toning roller 20, and tends to draw toner particle T₂ toward toning roller 20. Magnetic force M₄ exists between toner particle T₂ and a second magnetic toner particle T₃, and tends to draw toner particle T₂ toward toner particle T₃. None of magnetic forces M₂, M₃, and M₄ are directed toward dielectric support member or film 16. Rather, magnetic force M₃ is generally directed away from dielectric support member or film 16, and magnetic forces M₂ and M₄ are generally directed parallel to dielectric support member or film 16 and in opposing directions. Thus, magnetic forces M₂, M₃ and M₄ tend to counteract or reduce the effective electrical force E₂ that attracts magnetic toner particle T₂ to the electrostatic image charge carried by support member 16, and thereby degrade overall image quality.

Image quality is also degraded due to scavenging of toner particles from the electrostatic image carried on support member 16. This scavenging process occurs when a toner particle that has already been deposited on support member 16 is subsequently pulled back off the support member 16 by a subsequent carrier particle that is in close proximity to the toner particle. Scavenging is primarily responsible for the variation in the amount of toner deposited from the leading edge to the trailing edge of an image. Only as the image carried by support member 16 emerges from the developer nip area is the toner deposition relatively unaffected by the scavenging process, and thus heavier cross track lines and heavy trailing edges on other image shapes result.

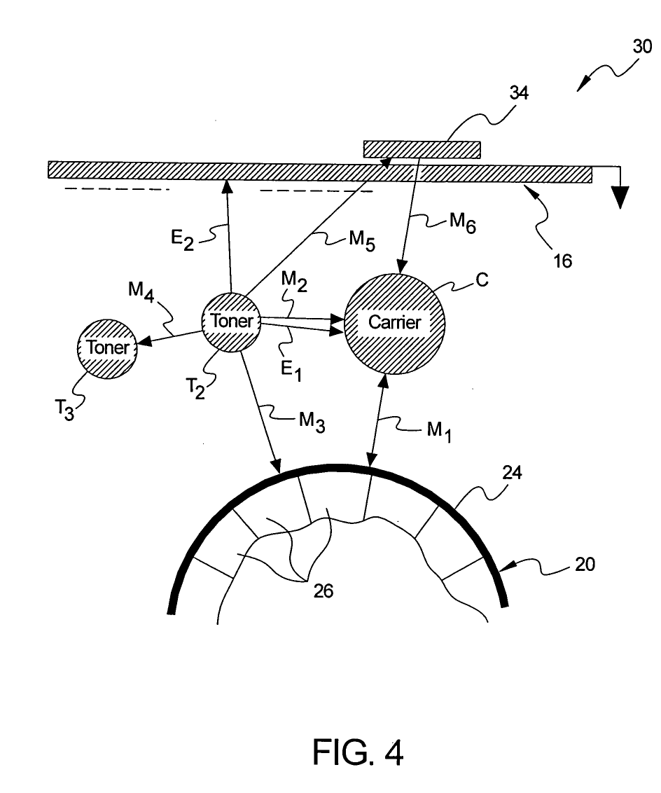

Referring now to FIG. 4, one embodiment of an electrographic development or printing machine 30 in accordance with the present invention is shown, and the electrical and magnetic forces acting within electrographic development machine 30 upon an exemplary toner particle having magnetic content T₂ and exemplary carrier particle C are illustrated.

Electrographic development machine 30 includes, in addition to toning roller 20 and dielectric support member or film 16, a magnetic keeper 34. Magnetic keeper 34, such as, for example, a wire or plate, disposed such that film or dielectric support member 16 is between keeper 34 and toner roller 20. Magnetic keeper 34 is constructed of a range of materials of varying ferromagnetic strength, such as, for example, a thin wire of slightly magnetic stainless steel having a relatively small amount of ferromagnetic material, such as, for example, 0.04 grams per centimeter of length, for very small ferromagnetic strength/effect to a cold rolled steel plate having a relatively large amount of ferromagnetic material, such as, for example, 16 grams per centimeter of length, for very strong ferromagnetic strength/effect. The amount of ferromagnetism and location of magnetic keeper 34 is dependent at least in part upon the desired effect on the toner deposition process. The relatively low magnetic reluctance of magnetic keeper 34 tends to draw or attract magnetic toner particle T₂, thereby counteracting the magnetic forces M₂, M₃ and M₄ which, as described above, tend to counteract or reduce the effective electrical force E₂ attracting magnetic toner particle T₂ to the electrostatic image charge carried by support member 16.

In electrographic development machine 30, as shown in FIG. 4, magnetic forces M₂, M₃, and M₄ act on magnetic toner particle T₂ in a substantially identical manner as described above in regard to electrographic development machine 10, i.e., magnetic forces M₂, M₃, and M₄ remain directed generally away from dielectric support member 16 and tend to degrade image quality. However, an additional magnetic force M₅ acts on magnetic toner particle T₂. More particularly, magnetic force M₅ exists between magnetic toner particle T₂ and magnetic keeper 34, and tends to draw magnetic toner particle T₂ toward keeper 34. Since keeper 34 is disposed between magnetic toner particle T₂ and dielectric support member 16, magnetic force M₅ is directed toward and tends to draw magnetic toner particle T₂ to dielectric support member 16. Thus, magnetic force M₅ is directed generally opposite to magnetic force M₃ and thereby counteracts or generally balances the magnetic forces acting on magnetic toner particle T₂ within development machine 30. With the magnetic forces generally balanced, the electrical forces acting on toner particle T₂ predominate and the above-described undesirable effects of the magnetic forces on the image are substantially reduced.

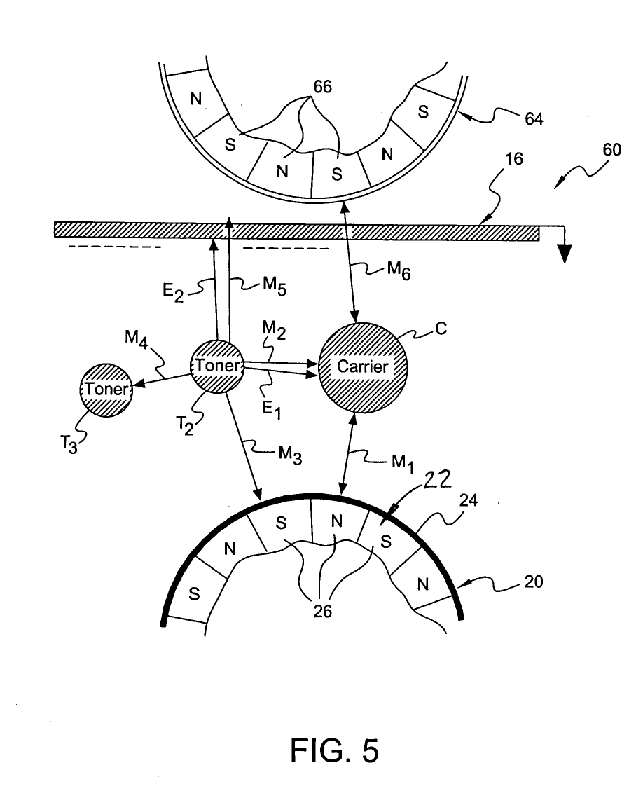

Referring now to FIG. 5, a second embodiment of an electrographic development or printing machine 60 in accordance with the present invention is shown, and the electrical and magnetic forces acting within electrographic machine 60 upon an exemplary toner particle having magnetic content T₂ and exemplary carrier particle C are illustrated. Whereas magnetic keeper 34 acts to straighten or balance magnetic field lines in a passive manner, the following embodiments of printing machines employ active structures to straighten/balance the magnetic field lines.

Electrographic development machine 60 includes, in addition to toning roller 20 and dielectric support member or film 16, a rotating magnetic 64. Rotating magnet 64 is disposed generally opposite toner roller 20, and with dielectric support member 16 disposed between rotating magnet 64 and toner roller 20. Rotating magnet 64 includes a plurality of magnets 66 arranged such that the poles thereof are opposite to the poles of magnets 26 of toner roller 20. Thus, the magnetic forces M₃ and M₅ are directed generally opposite to each other and approximately equal in magnitude. The magnetic forces acting on magnetic toner particle T₂ within electrographic development or printing machine 60 are therefore generally balanced, and the electrical forces predominate thereby substantially reducing the above-described undesirable effects of the magnetic forces on the image.

The phase angle between the rotating north and south poles can be adjusted to tune the magnetic field between the two core magnets 22 and 64. For example, a north pole on one core may be in phase with a north pole on the other such that their fields precisely cancel out. Having the poles exactly out of phase, with a north pole facing a south pole results in a strong field which varies from one direction to the other between the two core magnets. The phase angle between the rotating core magnets determines the effect on a magnetic toner particle. This phase angle can thus be adjusted to either strengthen the image lead or trail edge or to balance the toner deposit on the dielectric support member 16, thereby modifying the appearance of the toned image as desired.

Since the cores 22 and 64 can be computer controlled, field strength as well as direction can be programmed to improve image edge balance as well as helping to keep the background or interframe areas clean.

In the embodiments shown, a magnetic keeper 34 and a rotating magnet 64 are utilized as means for counteracting and generally balancing the magnetic forces acting on the magnetic toner particles within electrographic development machines 30 and 60, respectively. However, it is to be understood that the present invention can be alternately configured with various other means for balancing the magnetic forces within the electrographic development machines. Such means include various magnetic and/or electromagnetic structures, such as, for example, a wire coil electromagnet.

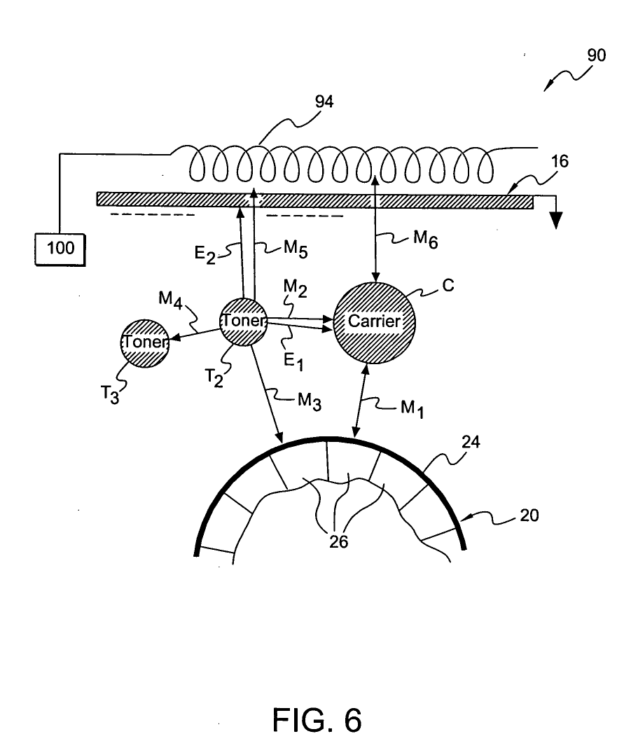

As shown in FIG. 6, electrographic development machine 90 utilizes a wire coil electromagnet 94 as the magnetic/electromagnetic structure to balance the magnetic forces within the development machine. Machine 90 also includes controller 100, such as, for example, a microprocessor that actively controls and drives electromagnet 94 to thereby manipulate the magnetic field characteristics on a real-time basis. Thus, machine 90 is able to reduce the effects of developer pickup and/or carrier pickup on image quality. Since the electromagnet 94 can be computer controlled, its level of the strength as well as its direction can be programmed to improve image edge balance as well as helping to keep the background or interframe areas clean.

It should be particularly noted that the magnetic or electromagnetic structure for balancing the magnetic forces within the development machine can range from the relative simplicity of the magnetic keeper 34 of electrographic machine 30 to the moderately complex rotating magnet 64 of machine 60 and beyond to structures that are substantially more complex and/or more powerful. These structures may be implemented to alter the magnetic field generated by the core 22 in the development zone, as has been described herein. The complexity or power required of the magnetic force balancing structure or means depends, at least in part, upon the configuration of particular development machine upon which the balancing structure is to be used including, such as, for example, the diameter or size of the toning roller, the number of magnets therein, and the magnetic forces in the nip area.

While this invention has been described as having a preferred design, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

What is claimed:

1. An electrographic development machine utilizing developer material having toner particles with magnetic content, said development machine comprising:
a dielectric film member configured for carrying an electrostatic image thereon;
a toner roller disposed upon a first side of said dielectric film member, said toner roller having a core and an outer shell, said core including a plurality of toner roller magnets, each of said toner roller magnets having a respective north and south pole, said toner roller magnets being disposed such that adjacent pairs thereof have poles of opposite polarity disposed proximate said shell, said toner roller providing said dielectric film member with a supply of developer material; and
means for balancing the magnetic forces acting on the toner particle with magnetic content.

2. The electrographic development machine of claim 1, wherein said means for balancing comprises a magnetic keeper disposed on a second side of said dielectric film member, said second side opposite said first side.

3. The electrographic development machine of claim 2, wherein said magnetic keeper is chosen from a group consisting of a wire, a rod, and a plate and is constructed at least in part of a ferromagnetic material.

4. The electrographic development machine of claim 1, wherein said means for balancing comprises an electromagnetic structure.

5. The electrographic development machine of claim 4, wherein said electromagnetic structure comprises a rotating magnet assembly disposed on a second side of said dielectric film member, said second side opposite said first side, said rotating magnet assembly disposed generally opposite said toner roller, said rotating magnet assembly including a plurality of assembly magnets, each of said plurality of assembly magnets having respective poles, said assembly magnets arranged such that said poles thereof are opposite in polarity to corresponding and opposing said poles of said toner roller magnets.

6. The electrographic development machine of claim 4, wherein said electromagnetic structure comprises a rotating magnet assembly disposed on a second side of said dielectric film member, said second side opposite said first side, said rotating magnet assembly disposed generally opposite said toner roller, said rotating magnet assembly including a plurality of assembly magnets, each of said plurality of assembly magnets having respective poles, said assembly magnets arranged such that said poles thereof are of the same polarity as said poles of said toner roller magnets.

7. The electrographic development machine of claim 4, wherein said electromagnetic structure comprises a rotating magnet assembly disposed on a second side of said dielectric film member, said second side opposite said first side, said rotating magnet assembly disposed generally opposite said toner roller, said rotating magnet assembly including a plurality of assembly magnets, each of said plurality of assembly magnets having respective poles, said assembly magnets arranged such that said poles thereof are phase shifted with respect to said poles of said toner roller magnets.

8. The electrographic development machine of claim 4, wherein said electromagnetic structure comprises an electromagnet.

9. The electrographic development machine of claim 1, wherein said means for balancing is encased in a material to facilitate cleaning.

10. The electrographic development machine of claim 1, further comprising a controller, said controller electrically connected to said means for balancing to thereby control in a generally real-time manner the magnetic field within the machine.

11. A method of counteracting development magnetic forces acting upon a toner particle having magnetic content within an electrographic development machine, comprising:
creating a balancing magnetic force that interacts with said development magnetic force.

12. The method of claim 11, said balancing force being approximately equal to said development magnetic force.

13. The method of claim 11, comprising disposing a magnetic keeper on a side of the dielectric support member that is opposite the side upon which the electrostatic image is disposed.

14. The method of claim 12, wherein said magnetic keeper is a ferromagnetic material chosen from a group consisting of a wire, a rod, and a plate.

15. The method of claim 11, comprising disposing a rotating magnet assembly on the side of said dielectric film member opposite the side upon which the electrostatic image is disposed.

16. The method of claim 11, comprising disposing an electromagnet on the side of said dielectric film member opposite the side upon which the electrostatic image is disposed.

17. A method of developing an image:
feeding a developer into contact with a dielectric member using a development magnet; and,
altering a magnetic field induced by said development magnet with a field altering structure disposed on a side of said dielectric member opposite said development electromagnet.

18. The method of claim 17, the developer comprising magnetic toner.

19. The method of claim 17, the field altering structure comprising ferromagnetic material chosen from a group consisting of wire, rod, and plate.

20. The method of claim 17, the field altering structure comprising a rotating magnet.

21. The method of claim 17, the field altering structure comprising an electromagnet.
